(19) United States
(12) Patent Application Publication
(10) Pub. No.: US 2020/0354585 A1
(43) Pub. Date: Nov. 12, 2020

(54) ECO-FRIENDLY PAINT COMPOUND

(71) Applicants: Maria Ramirez-Cervantes, N Hollywood, CA (US); Ed Abnousi, N Hollywood, CA (US)

(72) Inventors: Maria Ramirez-Cervantes, N Hollywood, CA (US); Ed Abnousi, N Hollywood, CA (US)

(21) Appl. No.: 16/408,320

(22) Filed: May 9, 2019

(51) Int. Cl. C09D 5/00; C09D 11/16

(52) U.S. Cl. CPC C09D 5/008; C09D 11/16

(57) ABSTRACT

A paint compound is presented. The paint compound is for use with an item. The paint compound is a composition having a predetermined consistency and is biodegradable and water-soluble. The paint compound is environmentally friendly. The paint compound is generally contained within a carrier such as a can, markers, pens, etc. The items that the paint compound may be used on may be any item such as a garment, whiteboard, stickers, decals, etc. Further, the paint compound is released from the item using water.

### FIELD OF THE INVENTION

This invention relates to a dissolvable paint compound, and more particularly, to liner-less dissolvable labels and tapes.

### BACKGROUND

Liner-less labels and tapes are typically manufactured by applying a pressure sensitive adhesive to the back side of a paper or synthetic continuous substrate or web and then applying a release coating to the face side of the substrate.

The resultant article is then wound upon itself to form a roll. The release coating on the face of the substrate permits the article to be unwound without the adhesive sticking to the substrate. The typical process for manufacturing liner-less labels and tapes is difficult to use when the substrate is a dissolvable paper.

Dissolvable papers generally have low Web Strength and tear easily during Subsequent processing steps, such as those required for producing liner-less labels and tapes, and for winding the liner-less tape and labels into a roll.

It is desirable, therefore, to provide a dissolvable liner-less adhesive article that can be wound upon itself, and then unwound while maintaining its integrity. It is further desirable to have an eco-friendly paint, that can be used by children and adults alike to make or add to their stickers, markers, brushes, etc.

### BRIEF DESCRIPTION OF THE DRAWINGS

FIG. 1A is a can containing the exemplary paint compound.

FIG. 1B is a set of markers containing the exemplary paint compound.

FIG. 2 is a view of coloring items with the exemplary paint compound.

FIG. 3 is a view of the colored items being cleaned with water.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

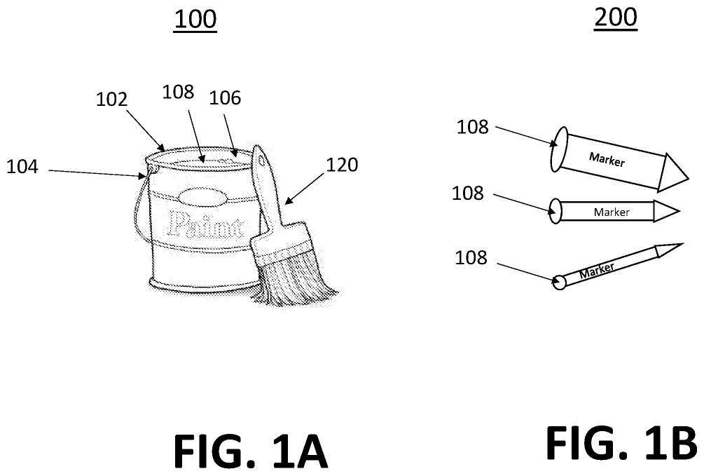

Referring to FIG. 1A and FIG. 1B, an exemplary paint compound is presented in different containers. FIG. 1A shows a carrier 100 marked “PAINT”. The carrier 100 has a round opening 102 and a cylindrical body 104. The carrier 100 can be a can 100 such as shown in FIG. 1A, one or more markers 200 as shown in FIG. 1B, pens, etc.

The can 100 is hollow on the inside 106. The inside 106 of the can 100 is used to hold a liquid such as a paint compound 108. An applicator for a can 100 of paint compound 108 is typically a brush 110. The paint compound 108 being a liquid and having a predetermined consistency. The paint compound 108 is typically stirred to form a consistent color and to return the setting paint compound 108 to the predetermined consistency.

The paint compound 108 is further made of a bio-degradable, water-soluble compounds, thus when the paint compound 108 is cleaned from the item it is eco-friendly. After the paint compound 108 has been mixed, the paint compound 108 may be used for multiple applications such as for arts and crafts for children making decals, stickers, brushes and for painting on different surfaces.

Further, the paint compound 108 can be useful for educational purposes such as whiteboard lessons, art classes, food labeling, consumer goods, etc.

Moving now to FIG. 1B, exemplary uses of the paint compound 108 is shown. The markers 200 contain the paint compound 108. Markers, such as the markers 200, typically leave some type of mark or residue behind, such as accidental use on walls or spills on carpet, whiteboards are relentlessly cleaned but can not be brought back to their pristine condition. With the markers 200 having the water-soluble, bio-degradable paint compound 108, those past left behind marks will no longer occur.

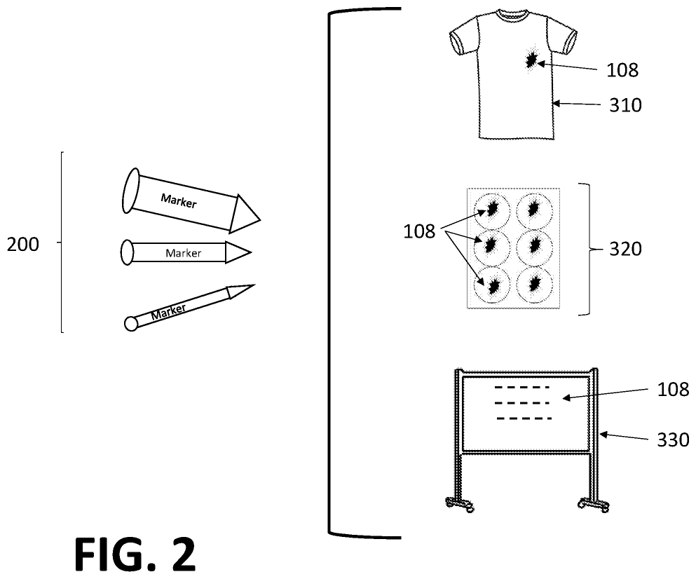

Referring now to FIG. 2, an exemplary use of the exemplary paint compound 108. The paint compound 108 is contained within a carrier 200. The carrier 200 is markers 200 in this example. The carrier 200 can be paint can 100, markers 200, pens, etc.

The person then selects the color of the paint compound 108 they wish to use. The marker 200 is selected that is the desirable color and the paint compound 108 is applied to an item. The item can be a garment such as a shirt 310, one or more stickers 320, a whiteboard 330, decals, food labels, consumer goods, etc.

The person would then select another color of the paint compound 108 and the marker 200 that corresponds to the desired color. The person then applies the color to the chosen item 320, 330, 340 into a pattern that the person desires.

The paint compound 108 is then displayed in the pattern on the chosen item. Any pattern may be used and displayed with any number of colors of the paint compound 108.

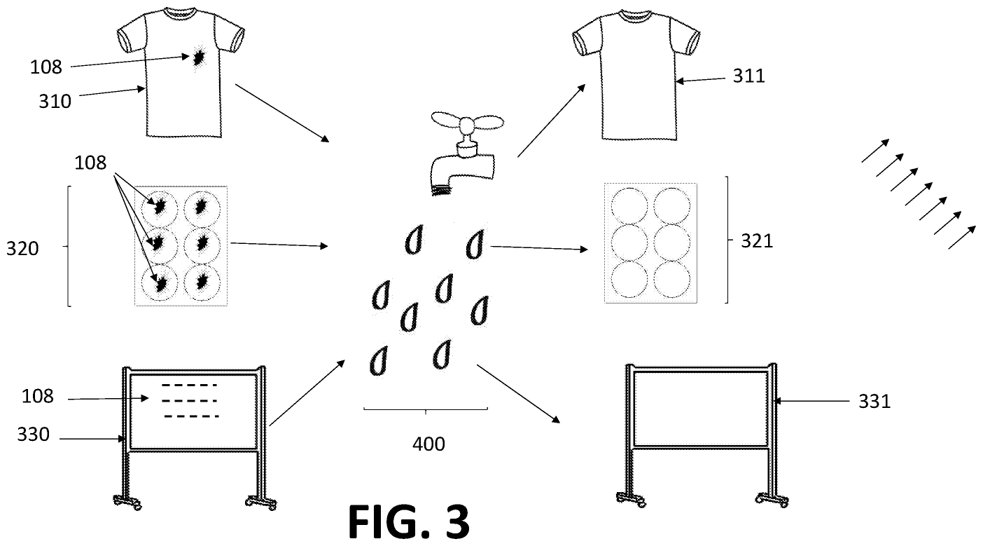

Now referring to FIG. 3, an exemplary removal of the paint compound 108 is described. The paint compound 108, as described earlier, is a water-soluble, bio-degradable eco-friendly compound. The item such as the shirt 310 and the stickers 320 are washed in a washer or put into water 400 and the paint is dissolved and the shirt 311 is clean of all residue of the paint compound 108 as is the stickers 321 are now free of all residue of the paint compound 108 that had previously been applied.

The whiteboard 330 has a pattern that has been painted onto it using the paint compound 108. Typically, a washcloth or paper towel would be wetted with water 400 and brushed along the whiteboard 330. The paint compound 108 is released from the whiteboard 330 and is soaked into the washcloth or paper towel or any other removal tool. The whiteboard 331 is now free of the paint compound 108.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A paint compound for use with an item, said paint compound comprising:
a composition having a predetermined consistency;
wherein said composition is biodegradable; and
wherein said composition is water-soluble.

2. The paint compound of claim 1, wherein said paint compound is eco-friendly.

3. The paint compound of claim 1, wherein said item comprises a garment.

4. The paint compound of claim 2, wherein said item comprises a sticker.

5. The paint compound of claim 2, wherein said paint compound is housed in a carrier.

6. The paint compound of claim 5, wherein said carrier comprises a marker.

7. The paint compound of claim 5, wherein said carrier comprises a pen.

8. The paint compound of claim 2, wherein said item comprises a decal.

9. The paint compound of claim 2, wherein said item comprises a temporary tattoo.

10. The paint compound of claim 2, wherein said item comprises a stamp.

11. A paint compound for use with an item, said paint compound comprising:
a composition having a predetermined consistency;
wherein said composition is biodegradable;
wherein said composition is water-soluble;
wherein said paint compound is eco-friendly;
wherein said item comprises a sticker;
wherein said paint compound is housed in a carrier; and
wherein said carrier comprises a marker.
